(19) United States
(12) Patent Application Publication
(10) Pub. No.: US 2008/0310650 A1
(43) Pub. Date: Dec. 18, 2008

(54) ACTIVE NOISE REDUCING DEVICE

(75) Inventors: Yoshio NAKAMURA, Osaka (JP); Masahide ONISHI, Osaka (JP); Shigeki YOSHIDA, Mie (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/572,848

(22) PCT Filed: Jul. 21, 2006
(86) PCT No.: PCT/JP2006/014451

§ 371 Date: Jan. 29, 2007

(30) Foreign Application Priority Data
Jul. 21, 2005 (JP) 2005-210920

(51) Int. Cl. H04B 15/00

(52) U.S. Cl. 381/94.1

(57) ABSTRACT

An active noise reducing device includes processing circuit includes a sine wave generator for generating a sine wave having a specific frequency, a cosine wave generator for generating a cosine wave having the same frequency as that of the sine wave, and two one-tap digital filters for processing the outputs from the generators. The processing circuit also has two coefficient updating sections, which output a sum of outputs from the digital filters. Updating sections update respective coefficients of the filters based on a sum of this output from the updating sections and respective inputs to the updating sections, and the respective outputs from the generators. The noise reducing device also has an adjusting circuit for adjusting the phase and amplitude of an output from the processing circuit, the adjusting circuit thus generates a control signal of opposite phase and equal in amplitude to original noise, so that random noise such as load noise can be reduced.

### TECHNICAL FIELD

The present invention relates to an active noise reducing device that generates an interference wave of opposite phase and equal in amplitude to unpleasant noise, so called load noise, generated in a vehicle interior by driving a vehicle, so that the interference allows reducing the noise.

### BACKGROUND ART

A conventional active noise reducing device employs a known feedback method. To be more specific, a microphone is placed at the place suffering subject noise to be reduced, and a signal collected by the microphone is processed by a phase and amplitude adjusting circuit such that the signal becomes opposite in phase to the original noise, then the processed signal is output as an interference wave from an electro-acoustic transducer such as a speaker, so that the noise at the place of the microphone can be reduced.

Another conventional device employs a known feed forward method available for this purpose: an adaptive N-tap digital filter receives a signal showing a strong correlation with subject noise, and the filter adaptively processes this input signal such that a signal collected by a microphone placed at the place suffering the subject noise becomes damp, then the processed signal is output as an interference wave from an electro-acoustic transducer such as a speaker, so that the noise at the place of the microphone can be reduced.

The prior art related to the present invention is disclosed in, e.g. Unexamined Japanese Patent Publication No. H03-203792.

The traditional feedback method discussed above has a drawback in the phase and amplitude adjusting circuit, which in general comprises analog elements such as capacitors, resistors, and an operational amplifier. However, the capacitor or the resistor has a tolerance, and those components supplied from volume production have errors deviated from an ideal design value. A steep characteristic or a complicated characteristic needs a large number of analog elements, so that the active noise reducing device becomes expensive and bulky.

The feed forward method discussed previously also has a drawback in the adaptive N-tap digital filter that generates a signal of opposite phase and equal in amplitude to the original noise. In order to properly work, this digital filter needs a digital signal processor performing high-speed calculations, and this high-speed processor is so expensive that it has retarded the cost reduction of the active noise reducing device.

As discussed above, the conventional active noise reducing device, which reduces random noise such as load noise, has not only a cost-oriented problem but also the problem of errors deviated from a design value due to the tolerance and the problem with a size of the device.

### DISCLOSURE OF INVENTION

The present invention addresses the foregoing problems and aims to provide an active noise reducing device which actively reduces random noises such as load noises. This device comprises the following element:

a processing circuit including:
a sine wave generator for generating a sine wave of a specific frequency;
a cosine wave generator for generating a cosine wave of the same frequency as that of the sine wave; and
two one-tap digital filters for processing respective outputs from the sine wave generator and the cosine wave generator.

The processing circuit further including two coefficient-updating sections for updating respective coefficients of the two one-tap digital filters based on the outputs from both of the sine wave generator and the cosine wave generator as well as an output formed of outputs added together from the two one-tap digital filters and an output from a transducer such as a microphone placed at a location suffering the subject noise to be reduced.

The active noise reducing device further comprises the following elements:
an adjusting circuit for adjusting a phase and an amplitude of an output from the processing circuit and generating a resulting signal; and
another transducer such as a speaker for radiating the signal supplied from the adjusting circuit as interference sound.

The structure discussed above allows eliminating the adversely affecting errors caused by the tolerance proper to the analog elements. The two adaptive one-tap digital filters handle so small amount of calculations that the filters need no high-speed digital signal processor that is needed by the feed forward method. As a result, the active noise reducing device can be available with an inexpensive microprocessor.

### BRIEF DESCRIPTION OF THE DRAWINGS

FIG. 1 shows a block diagram illustrating an active noise reducing device in accordance with an exemplary embodiment of the present invention.

FIG. 2 shows a block diagram for calculating the transmission characteristics of a processing circuit.

FIG. 3 shows an example of the transmission characteristics resulting from the block diagram shown in FIG. 2.

FIG. 4 shows a block diagram for finding the transmission characteristics of a processing circuit.

FIG. 5 shows the transmission characteristics of the processing circuit.

FIG. 6 shows transmission characteristics in response to changes of “μ” of the processing circuit.

FIG. 7 shows a block diagram illustrating sound-deadening operation of the active noise reducing device in accordance with an embodiment of the present invention.

FIG. 8 shows a block diagram illustrating a structure of an adjusting circuit.

FIG. 9 shows a block diagram illustrating an active noise reducing device in accordance with another embodiment of the present invention.

FIG. 10 shows the transmission characteristics of a processing circuit of the active noise reducing device in accordance with the foregoing another embodiment of the present invention.

### DESCRIPTION OF REFERENCE MARKS

101 processing circuit
102 sine wave generator
103 cosine wave generator
104, 105, 116 one-tap digital filter
106, 107 coefficient updating section
108 adjusting circuit
109 first transducer (speaker)
110 second transducer (microphone)
111 section corresponding to processing circuit
112 transmission coefficient of processing circuit
113 transmission coefficient of adjusting circuit
114 transmission coefficient of the first and second transducers including a space between the first and the second transducers
115 simplified processing circuit
117 block processing section

### PREFERRED EMBODIMENT OF THE PRESENT INVENTION

### Exemplary Embodiment

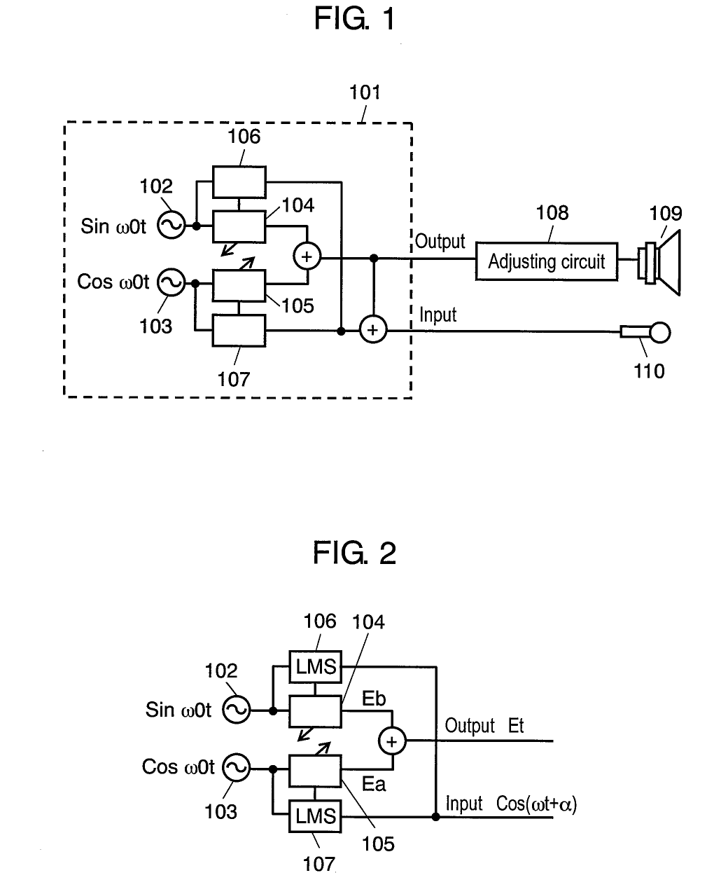

An active noise reducing device in accordance with an embodiment of the present invention is demonstrated hereinafter. FIG. 1 shows a block diagram illustrating the active noise reducing device in accordance with this exemplary embodiment of the present invention.

Processing circuit 101 comprises the following elements:
sine wave generator 102 for generating a sine wave of a specific frequency;
cosine wave generator 103 for generating a cosine wave of the same frequency as that of the sine wave;
two one-tap digital filters 104, 105 for processing respective outputs from sine wave generator 102 and cosine wave generator 103; and
two coefficient-updating sections 106, 107 for receiving an input thereto and the respective outputs from sine wave generator 102 and cosine wave generator 103.

These updating sections 106 and 107 update successively the coefficients of one-tap digital filters 104 and 105 respectively. An output from processing circuit 101 is adjusted its amplitude and phase by adjusting circuit 108, then supplied to first transducer 109 such as a speaker. An output from second transducer 110 such as a microphone is supplied to processing circuit 101. The feedback type active noise reducing device is thus constructed.

The noise reducing mechanism of the active noise reducing device shown in FIG. 1 and in accordance with this embodiment is demonstrated hereinafter. For this purpose, firstly the input-output characteristics of processing circuit 101 shown in FIG. 1 are described. FIG. 2 shows a block diagram for calculating transmission characteristics of the processing circuit, namely, the block diagram excluding the connection from the output to the input in processing circuit 101.

Processing circuit 101 receives input signal Cos(ωt+α), and sine wave generator 102 and cosine wave generator 103 generate Sin ωot and Cos ωot. Coefficient updating section 106, 107 update the coefficients of one-tap digital filters 104, 105 respectively, in general, by the least mean square (LMS) method. The updating equations are expressed as follows: (Bn=coefficient of filter 104, and An=coefficient of filter 105 are used in the following equations.)

An+1=An−μ·Cos(ωt+α)·Cos ωot

Bn+1=Bn−μ·Cos(ωt+α)·Sin ωot equations (1)

where, “μ” is a small coefficient called a convergence factor. Cos X, Sin X are expressed by using exponents as follows: (2)

$$Cos X = \frac{{∈}^{j X} + {∈}^{- j X}}{2} \\ Sin X = \frac{{∈}^{j X} - {∈}^{- j X}}{2 j} \qquad ( 2 )$$

First of all, changes ΔAn and ΔBn of the coefficients An, Bn of the adaptive filters are expressed by the following equations:

$$\begin{matrix}Δ An = - \frac{{∈}^{j ω \text{?}} + {∈}^{- j ω \text{?}}}{2} \times \\ \frac{{∈}^{j ( ω t + α )} + {∈}^{- j ( ω t + α )}}{2} \times μ \\ = - μ \frac{\begin{matrix}{∈}^{j ( ( {ω}_{\text{?}} + ω ) t + α )} + {∈}^{- j ( ( {ω}_{\text{?}} + ω ) t + α )} + \\ {∈}^{j ( ( {ω}_{\text{?}} - ω ) t - α )} + {∈}^{- j ( ( {ω}_{\text{?}} - ω ) t - α )}\end{matrix}}{4} \\ Δ Bn = - \frac{{∈}^{j ω \text{?} \text{?}} - {∈}^{- {jω}_{\text{?}} t}}{2 j} \times \\ \frac{{∈}^{j ( ω t + α )} + {∈}^{- j ( ω t + α )}}{2} \times μ \\ = - μ \frac{\begin{matrix}{∈}^{j ( ( {ω}_{0} + ω ) t + α )} - {∈}^{- j ( ( {ω}_{0} + ω ) t + α ) +} \\ {∈}^{j ( ( {ω}_{0} - ω ) t - α )} - {∈}^{- j ( ( {ω}_{0} - ω ) t - α )}\end{matrix}}{4 j}\end{matrix} \\ If we define {ω}_{0} + ω = ω x and {ω}_{0} - ω = ω y \\ Δ An = - μ \frac{\begin{matrix}{∈}^{j ( ω xt + α )} + {∈}^{- j ( ω xt + α )} + \\ {∈}^{j ( ω yt - α )} + {∈}^{- j ( ω yt - α )}\end{matrix}}{4} \\ Δ Bn = - μ \frac{\begin{matrix}{∈}^{j ( ω xt + α )} - {∈}^{- j ( ω xt + α )} + \\ {∈}^{j ( ω yt - α )} - {∈}^{- j ( ω yt - α )}\end{matrix}}{4 j} \\ \text{?} \text{indicates text missing or illegible when filed} \qquad equations ( 3 )$$

The resulting An, Bn are expressed by integrating the equations discussed above, i.e. the equations below:

$$An = {\int }_{ }^{ } Δ An = - \frac{μ}{4} ( \begin{matrix}\frac{{∈}^{j ( ω xt + α )}}{j ω x} + \frac{{∈}^{- j ( ω xt + α )}}{- j ω x} + \\ \frac{{∈}^{j ( ω yt - α )}}{j ω y} + \frac{{∈}^{- j ( ω yt - α )}}{- j ω y}\end{matrix} ) + A \\ Bn = \int Δ Bn = - \frac{μ}{4 j} ( \begin{matrix}\frac{{∈}^{j ( ω xt + α )}}{j ω x} - \frac{{∈}^{- j ( ω xt + α )}}{- j ω x} + \\ \frac{{∈}^{j ( ω yt - α )}}{j ω y} - \frac{{∈}^{- j ( ω yt - α )}}{- j ω y}\end{matrix} ) + B \qquad equations ( 4 )$$

Assume that the integral constant is 0 (zero), and since ωx>>ωy, the term of ωx can be neglected, so that the following equations are obtained.

$$An = - \frac{μ}{4} ( \frac{{∈}^{j ( ω yt - α )}}{j ω y} - \frac{{∈}^{- j ( ω yt - α )}}{j ω y} ) \\ Bn = - \frac{μ}{4 j} ( \frac{{∈}^{j ( ω yt - α )}}{j ω y} + \frac{{∈}^{- j ( ω yt - α )}}{j ω y} ) \qquad equations ( 5 )$$

Output signals from sine wave generator 102 and cosine wave generator 103 are added to the above results, so that outputs Ea, Eb from two one-tap digital filters 104, 105 are expressed by the following equations (6):

$$\begin{matrix}Ea = \int Δ An \times \frac{{∈}^{j {ω}_{0} t} + {∈}^{- j {ω}_{0} t}}{2} \\ = ( - \frac{μ}{4} ( \frac{{∈}^{j ( ω yt - α )}}{j ω y} - \frac{{∈}^{- j ( ω yt - α )}}{j ω y} ) ) \times \\ \frac{{∈}^{j {ω}_{0} t} + {∈}^{- j {ω}_{0} t}}{2} \\ = - \frac{μ}{8 j ω y} ( {∈}^{j ( ω yt - α )} - {∈}^{- j ( ω yt - α )} ) \\ ( {∈}^{j {ω}_{0} t} + {∈}^{- j {ω}_{0} t} ) \\ = - \frac{μ}{8 j ω y} ( \begin{matrix}{∈}^{j ( ( ω y + {ω}_{0} ) t - α )} - {∈}^{- j ( ( ω y + {ω}_{0} ) t - α )} + \\ {∈}^{j ( ( ω y - {ω}_{0} ) t - α )} - {∈}^{- j ( ( ω y - {ω}_{0} ) t - α )}\end{matrix} )\end{matrix} \\ \begin{matrix}Eb = \int Δ Bn \times \frac{{∈}^{j {ω}_{0} t} - {∈}^{- {jω}_{0} t}}{2 j} \\ = ( - \frac{μ}{4 j} ( \frac{{∈}^{j ( ω yt - α )}}{j ω y} + \frac{{∈}^{- j ( ω yt - α )}}{j ω y} ) ) \times \frac{{∈}^{{jω}_{0} t} - {∈}^{- j {ω}_{0} t}}{2 j} \\ = \frac{μ}{8 jω y} ( {∈}^{j ( ω yt - α )} + {∈}^{- j ( ω yt - α )} ) ( {∈}^{j {ω}_{0} t} - {∈}^{- j {ω}_{0} t} ) \\ = \frac{μ}{8 jω y} ( \begin{matrix}{∈}^{j ( ( ω y + {ω}_{0} ) t - α )} - {∈}^{- j ( ( ω y + {ω}_{0} ) t - α )} - \\ {∈}^{j ( ( ω y - {ω}_{0} ) t - α )} + {∈}^{j ( ( ω y - {ω}_{0} ) t - α )}\end{matrix} )\end{matrix} \qquad equations ( 6 )$$

Then output Et can be expressed by the following equation (7):

$$\begin{matrix}Et = \int Δ An \times \frac{{∈}^{j {ω}_{0} t} + {∈}^{- {jω}_{0} t}}{2} + \\ \int Δ Bn \times \frac{{∈}^{{jω}_{0} t} - {∈}^{- j {w}_{0} t}}{2 j} \\ = - \frac{μ}{4 j ω y} ( {∈}^{j ( ( ω y - {ω}_{0} ) t - α )} - {∈}^{- j ( ( ω y - {ω}_{0} ) t - α )} ) \\ = \frac{μ}{2 ω y} ( \frac{{∈}^{j ( ( ω y - {ω}_{0} ) t - α )} - {∈}^{- j ( ( ω y - {ω}_{0} ) t - α )}}{- 2 j} ) \\ = \frac{μ}{2 ( {ω}_{0} - ω )} ( \frac{{∈}^{j ( ω t + α )} - {∈}^{- j ( ω t + α )}}{2 j} ) \\ = \frac{μ}{2 ( {ω}_{0} - ω )} Sin ( ω t + α )\end{matrix} \qquad equations ( 7 )$$

In other words, equations (7) show an output signal to which Cos(ωt+α) is added as an input, and when ω<ω₀, this output signal delays from the input signal by 90 degrees in phase, and when ω=ω₀, the phase advances by 180 degrees, and when ω>ω₀, the phase advances by 90 degrees. In terms of amplitude, when ω=ω₀, the amplitude becomes infinite, and as 0) becomes far away from ω₀, the amplitude lowers inversely proportional to |ω₀−ω|.

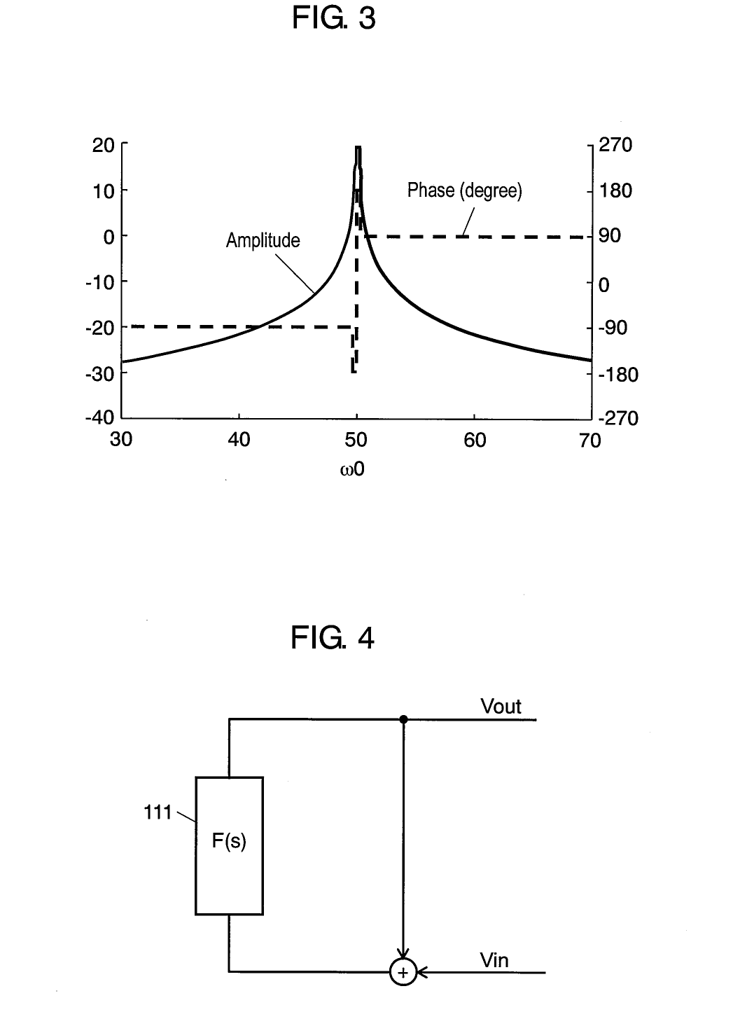

FIG. 3 shows the transmission characteristics calculated by the block diagram shown in FIG. 2. Next, the transmission characteristics of processing circuit 101 is described hereinafter. FIG. 4 shows a block diagram for finding the transmission characteristic of the processing circuit. In other words, FIG. 4 illustrates that an output of the block diagram shown in FIG. 2 is fed back to the input so that the block diagram shown in FIG. 2 can work as processing circuit 101. Section 111 shown in FIG. 4 and corresponding to the processing circuit shown in FIG. 2 has transmission function F(S) which is assumed to express the characteristics shown in FIG. 3. In such a case, the transmission characteristics of the block diagram shown in FIG. 4 is expressed by the following equation (8):

$$\frac{Vin}{Vout} = \frac{1}{1 - F ( s )} \qquad equation ( 8 )$$

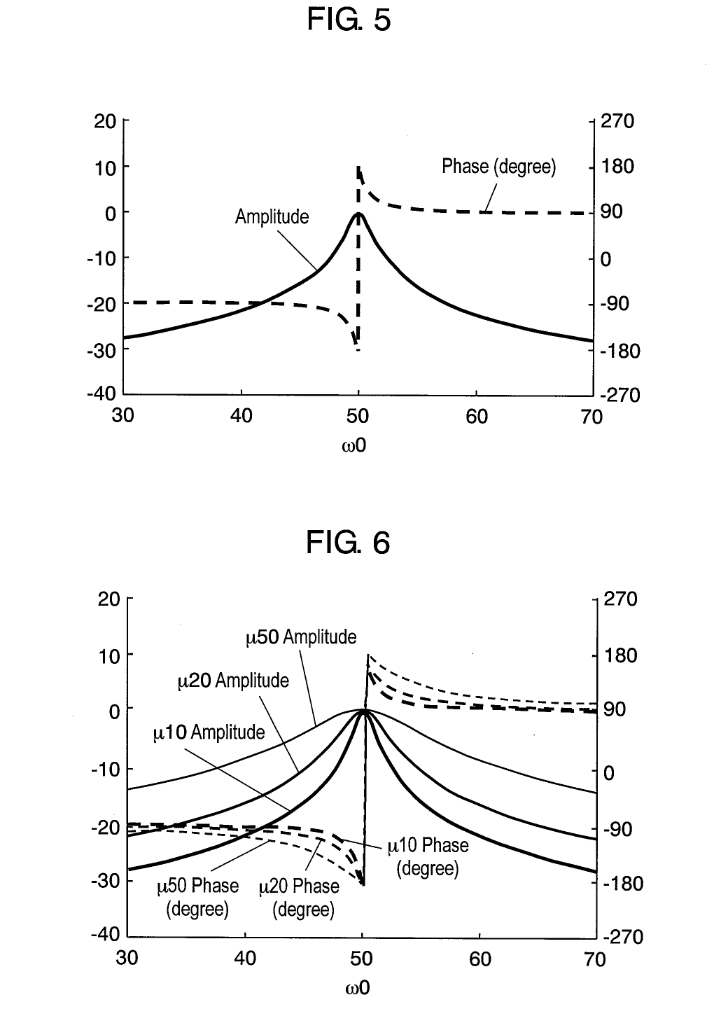

FIG. 5 shows the transmission characteristics of the processing circuit, namely the transmission characteristics expressed by equation (8). FIG. 5 tells that processing circuit 101 has the characteristics of band-pass filter having its center at ω₀. FIG. 5 also tells that phase is 180 degrees at ω₀.

Since ω₀ is an occurrence frequency of sine wave generator 102 and cosine wave generator 103, the center frequency of this band-pass characteristic can be changed with ease by varying the occurrence frequency of sine wave generator 102 and cosine wave generator 103. The bandwidth of this band-path characteristic can be also changed with ease by varying “μ” with equation (7). FIG. 6 shows the variation of the transmission characteristic in response to the changes of “μ”.

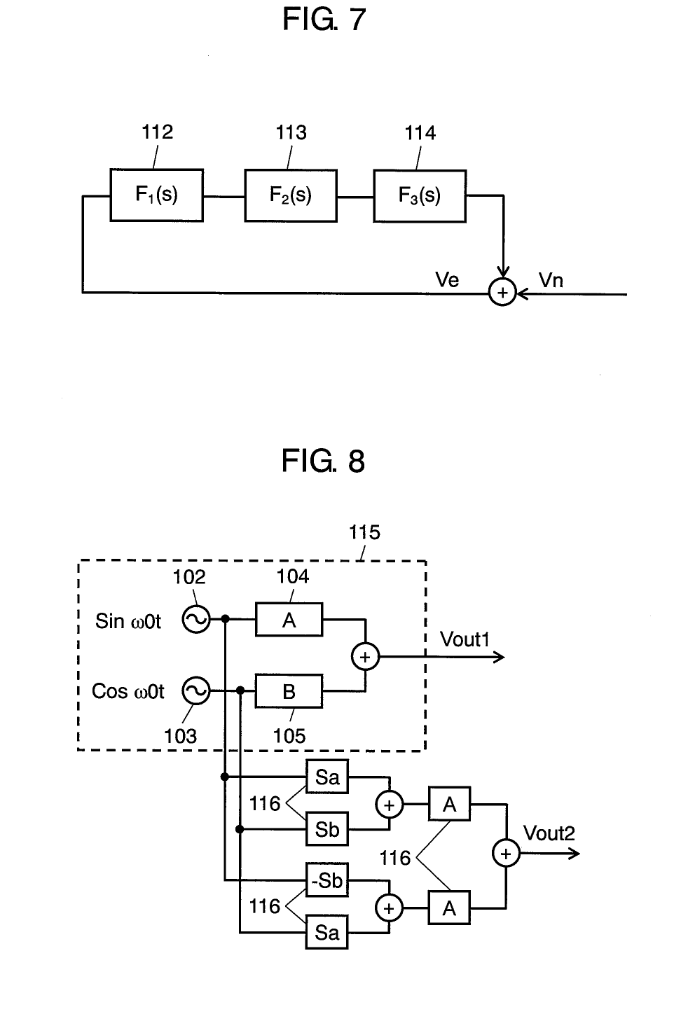

Next, a sound deadening mechanism as a whole is demonstrated hereinafter. FIG. 7 shows a block diagram illustrating sound-deadening operation of the active noise reducing device in accordance with this embodiment of the present invention. In FIG. 7, section 112 corresponding to the processing circuit has transmission characteristic which is expressed with F1(S), and the adjusting circuit has transmission characteristic expressed with F2(S). Transmission characteristic 114 of the first and second transducers including the space between the first and second transducers is expressed with F3(S). Input Vn corresponds to the original noise, and Ve is the noise having undergone the control. The relation between Vn and Ve is expressed by the following equation:

$$\frac{Ve}{Vn} = \frac{1}{1 - {F}_{1} ( s ) \cdot {F}_{2} ( s ) \cdot {F}_{3} ( s )} \qquad equation ( 9 )$$

This equation (9) indicates that noise Ve after the control is smaller than original noise Vn when the absolute value of 1−F1(S)×F2(S)×F3(S) is greater than 1 (one). In other words, when the phase is 180 degrees, F1(S)×F2(S)×F3(S) in terms of frequency characteristics produces a greater control effect as its gain becomes greater.

In the case of the present invention, the characteristics of F1(S) is shown in FIG. 1, so that F2(S)×F3(S) is selected such that the phase of F2(S)×F3(S) becomes 0 degree at ω₀. In general, F3(S) is the transmission characteristics of first transducer 109 and second transducer 110 including the space between transducers 109 and 110, so that F3(S) cannot be set at any value, but it is dedicatedly adjusted by F2(S), i.e. adjusting circuit 108, which adjust F2(S) such that the phase of F2(S)×F3(S) becomes 0 degree at ω₀.

FIG. 8 shows block diagram illustrating a structure of the adjusting circuit. Although adjusting circuit 108 can be formed of an analog circuit, FIG. 8 shows the circuit formed of a digital circuit. Processing circuit 101 is simplified into block diagram 115 shown in FIG. 8, where the coefficients of respective two one-tap digital filters 104, 105 are represented by A, B. As shown in FIG. 8, one-tap digital filter 116 has coefficients Sa, Sb, −Sb, Sa, A, and A. Output Vout 1, which is the sum of respective outputs of two one-tap digital filters 104, 105, is calculated by the following equation (10), and output Vout2, sum of six outputs of one-tap digital filters 116 is calculated by equation (10).

$$Vout 1 = \sqrt{{A}^{2} + {B}^{2}} Sin ( ω ot + arc tan ( B / A ) ) \\ Vout 2 = \sqrt{{Sa}^{2} + {Sb}^{2}} \sqrt{{A}^{2} + {B}^{2}} Sin ( ω ot + arc tan ( B / A ) + arc tan ( Sb / Sa ) ) \qquad equations ( 10 )$$

Equations (10) tell that Vout2 advances with respect to Vout1 in amplitude by times and in phase by arctan(Sb/Sa).

Appropriate selection of coefficients Sa, Sb of one-tap digital filter 116 allows adjusting the amplitude and the phase, so that no errors due to tolerance occur although the analog circuits properly have the tolerances.

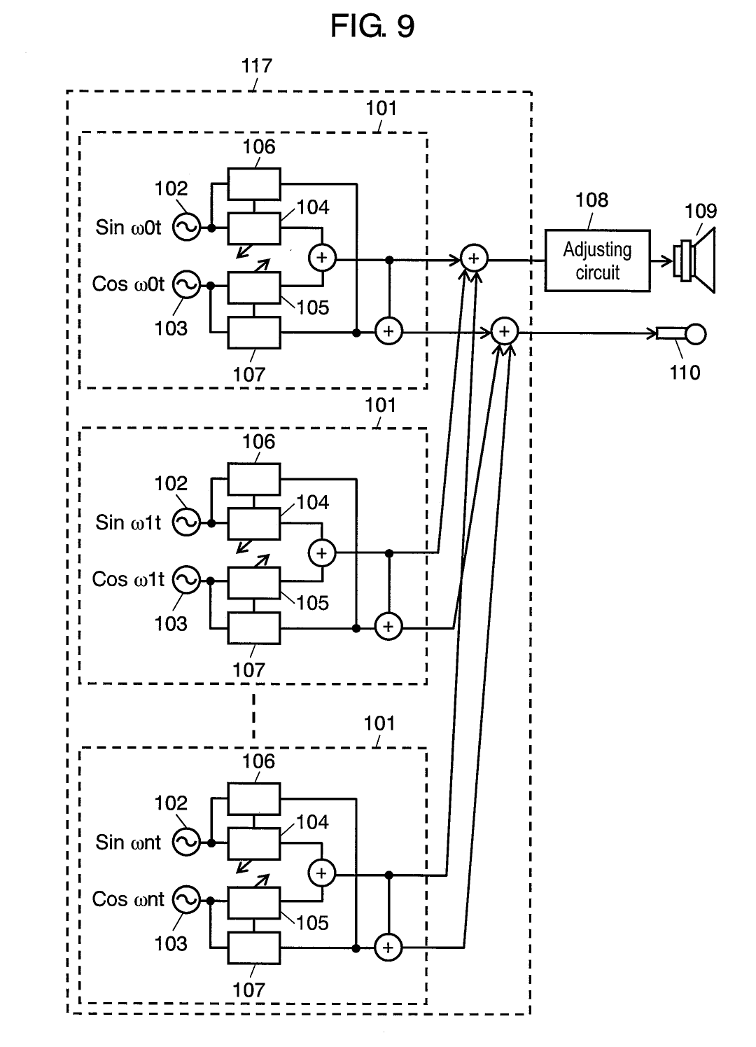

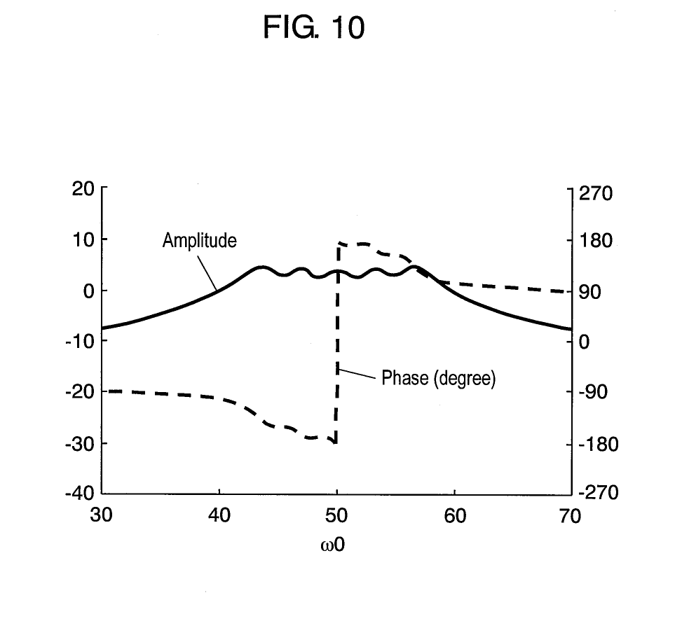

FIG. 9 shows a block diagram illustrating an active noise reducing device in accordance with another embodiment of the present invention. In FIG. 9, a plurality of processing circuits 101, working at different frequencies from each other, are coupled in parallel with each other, thereby forming the active noise reducing device. In block processing section 117, the processing circuits are coupled in parallel with each other. FIG. 10 shows transmission characteristics of the processing circuits of the active noise reducing device in accordance with the foregoing another embodiment of the present invention. Comparison of FIG. 10 with FIG. 5 tells that the passing band of the band-pass characteristics shown in FIG. 10 is wider than that shown in FIG. 5, so that the active noise reducing device in accordance with the another embodiment can reduce the noise in a wider band.

### INDUSTRIAL APPLICABILITY

An active noise reducing device of the present invention generates a simple and digital control signal of opposite phase and equal in amplitude to original noise, thereby achieving an inexpensive and highly practical active noise reducing device, which is useful for cars.

1. An active noise reducing device comprising:
a processing circuit including:
a sine wave generator for generating a sine wave of a specific frequency;
a cosine wave generator for generating a cosine wave of an identical frequency to the sine wave; and
two one-tap digital filters for processing respective outputs from the sine wave generator and the cosine wave generator;
an adjusting circuit for adjusting a phase and an amplitude of an output from the processing circuit;
a first transducer for transducing an output from the adjusting circuit into a sound wave or a vibration; and
a second transducer for transducing a sound wave or a vibration supplied to the processing circuit into an electrical signal,
wherein the processing circuit further includes two coefficient-updating sections for updating respective coefficients of the two one-tap digital filters,
wherein the two coefficient-updating sections update the respective coefficients of the two one-tap digital filters based on an output which is added a sum of outputs added together from the two one-tap digital filters and an input, and the respective outputs from the sine wave generator and the cosine wave generator.

2. The active noise reducing circuit of claim 1, wherein two or more than two of the processing circuits are coupled to each other in parallel, and the processing circuits respectively generate a sine wave and a cosine wave having different frequencies from each other.
